(19) United States
(12) Patent Application Publication
(10) Pub. No.: US 2016/0069456 A1
(43) Pub. Date: Mar. 10, 2016

(54) PISTON RING HAVING VARYING ATTRIBUTES

(71) Applicant: FEDERAL-MOGUL FRIEDBERG GMBH, Friedberg (DE)

(72) Inventors: MARKUS MAHL, DASING/TAITING (DE); REINHARD LAUMEYER, NEUSASS (DE); JOHANN RIEDL, FRIEDBERG (DE); FRANK NATHEM, MERING (DE)

(21) Appl. No.: 14/783,926

(22) PCT Filed: Apr. 9, 2014
(86) PCT No.: PCT/EP2014/057154

§ 371 Date: Oct. 12, 2015

(30) Foreign Application Priority Data
Apr. 11, 2013 (DE) 10 2013 206 399.7

(51) Int. Cl. F16J 9/20

(52) U.S. Cl. CPC F16J 9/20

(57) ABSTRACT

The invention relates to a piston ring having an outside circumferential surface, an inside circumferential surface and two flanks, wherein the circumferential surface has a spherical profiling, and wherein the axial width of the bearing surface and/or the angle between the bearing surface and at least one flank and/or the radius of the profiling vary periodically over the circumference of the piston ring.

The present invention relates to a piston ring with periodically varying attributes, in particular a piston ring with periodically varying bearing surface width or witness line width, varying angle between bearing surface and flank or varying radius of the bearing surface profile, for an internal combustion engine or compressor.

Modern large-volume engines for ships are usually two-stroke diesel engines since these engines can be designed so that their rotational speed typically lies in a range of about 50 rpm to 250 rpm (typically below 100 rpm) and their power can reach up to about 100 MW according to the number of cylinders. Such large-volume, slowly running two-stroke ships' engines preferably act directly on the drive shaft(s) of the propeller(s) since as a result of their rotational speed, a reducing gear to reduce the rotational speed can be dispensed with.

Typically such large-volume two-stroke engines have two separate oil circuits, one for the engine lubrication and one for the cylinder lubrication. The cylinder lubrication ensures that at a suitable time sufficient lubricating oil is provided to ensure sufficient lubrication of the cylinder surfaces or the piston rings.

Depending on the load of the machine, the cylinder lubricating oil is injected through the liner into the piston chamber. The piston rings or their bearing surface run on this lubricating film. During operation of the engine a narrow oil film, the so-called witness line, forms between the bearing surface and the liner. In this case, inter alia it is a question of injecting as little lubricating oil as possible in order to save costs and prevent overlubrication. The cylinder lubrication is accomplished, for example, in the upper stroke third, whereby lubricating oil is supplied to the cylinder by a lubricating oil pump through lubricating oil inlets provided, for example, in one plane in the cylinder wall so that as optimal as possible lubrication of the piston and the piston ring is ensured. The oil supply into the cylinder is usually accomplished by the gas counter pressure method.

For example, a lubricating oil injection system can be used which injects lubricating oil in a precisely metered manner via nozzles into the cylinder. A computer-controlled system registers the position in which a piston is located and then specifically supplies lubricating oil. This is accomplished at high pressure so that the lubricating oil is very finely sprayed in order to achieve as uniform as possible wetting of the cylinder liner specifically there when the piston rings are located and where the friction actually takes place.

Bearing in mind that modern large-volume two-stroke ships' engines having a rotational speed of about 50 rpm to 250 rpm are operated at a stroke of up to 2500 mm, the time interval available for the supply of the lubricating oil and the distribution of the supplied lubricating oil is small and poses major challenges for ensuring the quality of the lubrication. If it is assumed, for example, that a cylinder has an (inside) diameter of 900 mm and eight accesses distributed uniformly over the circumference must be provided for the oil supply in the cylinder wall, the supplied lubricating oil must be distributed starting from the respective accesses in the time interval provided over a length of about 350 mm in the circumferential direction of the piston ring.

It is shown that with the conventional design of the one or the plurality of piston rings as a result of the lack of pressure gradients in the circumferential direction, none or merely a very narrow distribution or movement (maximum about 3%) of the lubricating oil in the circumferential direction or tangential direction is obtained. On the other hand, the lubricating oil moves principally (about 97%) in the running direction or axial direction of the piston ring.

The area of application of the present invention is internal combustion engines and piston compressors in general, also outside ships' use.

The object of the present invention is to provide a piston ring which as a result of improved distribution of the lubricating oil, also ensures sufficient lubrication conditions in the circumferential direction and which ensures both a lower oil consumptions and lower blow-by and which is also favourable to produce.

According to one aspect of the invention, a piston ring having an outside circumferential surface, an inside circumferential surface and two flanks is provided, wherein the circumferential surface has a spherical profiling, and wherein
the spherical profiling has a substantially flat apex region which defines the bearing surface of the piston ring, and wherein the axial width of the bearing surface varies periodically over the circumference of the piston ring; and/or
the spherical profiling has a substantially flat apex region which defines the bearing surface of the piston ring, and wherein the angle between the bearing surface and at least one flank varies periodically over the circumference of the piston ring; and/or
wherein the radius of the spherical profiling varies periodically over the circumference of the piston ring.

According to the invention, a new type of bearing surface profile is proposed for a piston ring. The bearing surface of the piston ring has a substantially convex spherically configured profiling with an apex region. In the region of the apex the piston ring abuts against the liner during operation, i.e., the apex region defines the bearing surface of the piston ring. According to the invention, one or several of the attributes “axial width of the bearing surface”, “angle between the bearing surface and at least one flank” and “radius of the spherical profiling” varies or vary.

In a first alternative the axial width of this bearing surface varies in the circumferential direction, in other words the axial width of the bearing surface varies as a function of the angular position along the circumference. In the same way, the witness line of the lubricating oil formed during operation between bearing surface and liner varies with the variable width of the bearing surface.

In a second alternative, the angle between the bearing surface and at least one flank varies over the circumference of the piston ring. In other words, the area between bearing surface and flank(s) decreases with varying steepness in the direction of the flank.

In a third alternative, the radius of the spherical profiling varies over the circumference of the piston ring. It should be noted that in this embodiment it is not absolutely necessary that a substantially flat bearing surface is present. The configuration of a broader or narrower witness line can also be achieved here merely by the larger or smaller angle of the spherical profiling. In a likewise possible variant with a substantially flat apex region, the radius relates to a fictitious profiling without the apex region (i.e. to a fictitious profiling without the apex region).

These alternatives can also be arbitrarily combined.

A bearing surface of the piston ring configured in such a manner therefore has the effect that in continuous operation hydrodynamic pressures build up in the circumferential direction as a result of the variable witness line width or the variable angle or the variable radius. These hydrodynamic pressures lead to pressure gradients which cause lubricating oil fluxes and bring about a redistribution of the lubricating oil in the circumferential direction or tangential direction. The hydrodynamically effected redistribution of the lubricating oil leads to a reduction in the required supply and a more uniform and more rapid distribution in the circumferential direction of the supplied or injected lubricating oil.

According to one embodiment, the axial position of the centre of the bearing surface varies periodically. As a result, the formation of pressure gradients can be intensified.

According to one embodiment, the variation of the width and/or the position of the centre of the bearing surface comprises at least one complete period. Preferably the number of complete period. Preferably the number of complete periods is between 4 and 34. The number of periods can be adapted to the number of feed-through accesses through which the lubricating oil is pressed or injected into the cylinder, for example in the gas counter-pressure method. Thus, for example, the number of periods can be equal to the number of feed-through passages or nozzles or be an integer multiple thereof.

According to one embodiment, the variation of the width and/or the position of the centre of the bearing surface and/or the variation of the angle between the bearing surface and the at least one flank and/or the variation of the radius of the bearing surface profile is symmetrical in relation to the ring joint of the piston ring.

According to an alternative embodiment
the variation of the width and/or the position of the centre of the bearing surface is asymmetrical in relation to the ring joint of the piston ring;
   and/or
the variation of the angle between the bearing surface and the at least one flank is asymmetrical in relation to the ring joint of the piston ring;
   and/or
the variation of the radius of the spherical profiling is asymmetrical in relation to the ring joint of the piston ring;
   and/or
the behaviour of the variation of the width and/or the position of the centre of the bearing surface when viewed in the circumferential direction of the piston ring, is different per circumferential direction;
   and/or
the behaviour of the variation of the angle between the bearing surface and the at least one flank when viewed in the circumferential direction of the piston ring, is different per circumferential direction;
   and/or
the behaviour of the variation of the radius of the spherical profiling when viewed in the circumferential direction of the piston ring, is different per circumferential direction.

In particular, as a result of the variant of the different behaviour per circumferential direction, the pressure gradients can be produced with a type of “running direction binding” or the lubricating oil flow produced by hydrodynamic pressures and pressure differences can thus be specifically produced so that more oil flows in the one circumferential direction/the oil flows faster than in the opposite circumferential direction. For example, this could be achieved by an approximately sawtooth-like variation whose ascending or descending flanks ascend/descend more strongly in one direction of revolution than in the opposite direction of revolution.

As a result, forces act conversely on the piston ring ?? in the direction of rotation defined by this preferred direction of the variable bearing surface width/centre-to-centre position. As a result, if desired a rotation of the piston ring can be excited so as to avoid any seizing and make the wear more uniform.

According to one embodiment, an edge of the bearing surface runs parallel to the neighbouring flank. The variation of the bearing surface width thus takes place in such a manner that the hydrodynamic pressures or pressure gradients only occur at the other edge of the bearing surface. By this means it can be achieved that lubricating oil fluxes are specifically only excited on this side—for example, the side facing away from the combustion chamber—of the piston ring.

According to one embodiment, both edges of the bearing surface each have apexes at which the axial distance from the neighbouring flank has a minimum and wherein the apexes are disposed in the circumferential direction alternately on respectively one of the opposite edges of the bearing surface. These apexes can have a rounded shape but preferably relatively pointed apexes can be provided in order to produce locally intensified pressure gradients. This is particularly suitable where supply points or injection points for the lubricating oil are arranged in order to distribute the oil as fast as possible from there.

According to one embodiment, the axial width has a maximum at the apexes.

According to one embodiment, the minimum axial width of the bearing surface is 20% of the maximum width.

According to one embodiment, the axial width of the bearing surface is between 0.1 and 3 cm, preferably between 0.2 and 1.5 cm.

According to one embodiment, the axial width of the bearing surface is 5% to 50% of the axial width of the piston ring.

According to one embodiment, the variation of the width or the variation of the angle or the variation of the radius is a variation whose ascending or descending flanks ascend/descend more strongly in one direction of revolution than in the opposite direction of revolution in relation to the ring joint. This can, for example, be a sawtooth-like variation.

Oil transport in the circumferential direction is achieved as a result of the different variation according to circumferential direction. In the case of variation of the width, the oil transport takes place in the direction in which the width increases. In the case of variation of the angle, the oil transport takes place in the direction in which the angle increases.

### BRIEF DESCRIPTION OF THE DRAWINGS

The invention is explained in detail hereinafter with reference to the exemplary embodiments depicted in the figures, wherein

FIG. 1 shows a radial top view of a part of the outer circumferential surface of a first embodiment of a piston ring according to the invention;

FIG. 2 shows three different cross-sectional views through a piston ring according to FIG. 1;

FIG. 3 shows a piston ring according to FIGS. 1 and 2 in axial top view;

FIG. 4 shows a radial top view of a part of the outer circumferential surface of a second embodiment of a piston ring according to the invention;

FIG. 5 shows two different cross-sectional views through a piston ring according to FIG. 4;

FIG. 6 shows a piston ring according to FIGS. 4 and 5 in axial top view;

FIG. 7 shows a radial top view of a part of the outer circumferential surface of a third embodiment of a piston ring according to the invention;

FIG. 8 shows two different cross-sectional views through a piston ring according to FIG. 7;

FIG. 9 shows a piston ring according to FIGS. 7 and 8 in axial top view;

FIG. 10 shows two different cross-sectional views through a piston ring according to a fourth embodiment;

FIG. 11 shows a radial top view of a piston ring according to FIG. 10;

FIG. 12 shows two different cross-sectional views through a piston ring according to a fifth embodiment;

FIG. 13 shows a radial top view of a piston ring according to FIG. 12;

FIG. 14 shows a radial top view of a piston ring according to a sixth embodiment;

FIG. 15 shows a radial top view of a piston ring according to a seventh embodiment;

FIG. 16 shows a radial top view of a piston ring according to an eighth embodiment;

FIG. 17 shows a radial top view of a piston ring according to a ninth embodiment;

FIG. 18 shows two different cross-sectional views through a piston ring according to a tenth embodiment; and

FIG. 19 shows a top view of the piston ring from FIG. 18.

### DETAILED DESCRIPTION

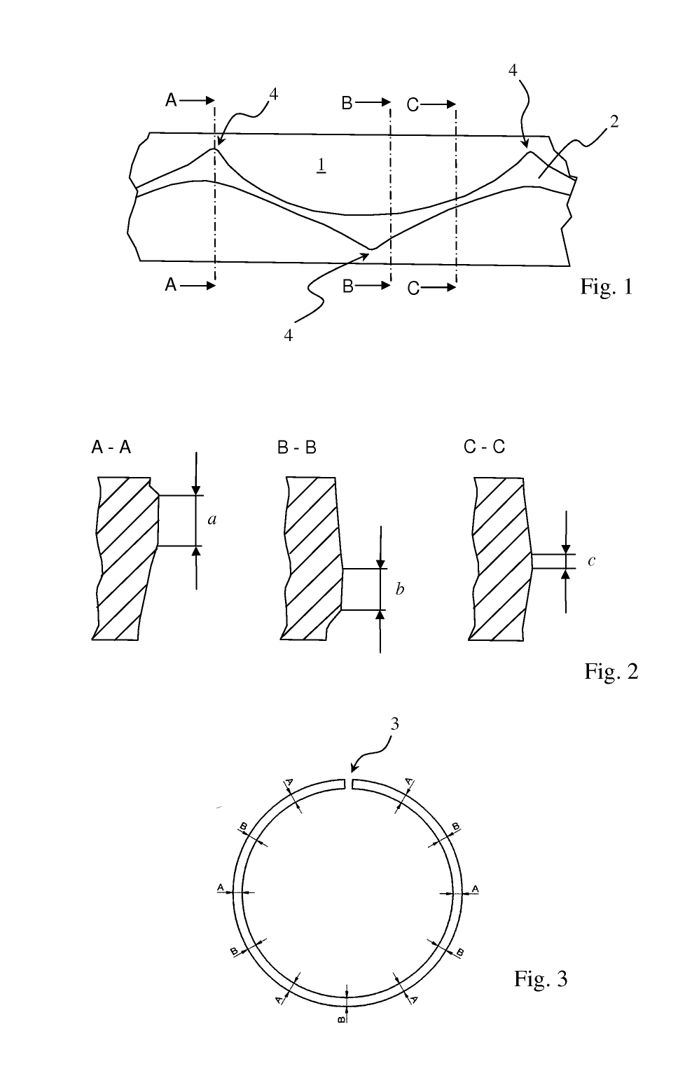

FIG. 1 shows a top view of the bearing surface side of a first embodiment of a piston ring 1 according to the invention. The piston ring 1 has a profiling which has a substantially flat apex region through which the actual bearing surface 2 of the piston ring 1 is defined. In operation the bearing surface 2 forms the contact surface with the cylinder liner or the cylinder inner side. An oil film, the so-called witness line, will build up on the bearing surface 2 in the lubricated state during operation.

As a result of the reciprocating movement of the piston, the lubricating oil is moved substantially only in the axial direction, i.e. up or down in the figure and is distributed and spread. In conventional piston rings, at best an extremely slight distribution (maximum 3%) of the amount of lubricating oil is accomplished in the tangential direction, i.e. in the circumferential direction of the piston ring. In order to nevertheless obtain a sufficient lubrication in conventional piston rings, possibly the large piston rings of ships' engines, on the one hand a relatively large amount of oil must be injected or supplied and on the other hand, the lubricating oil must be provided distributed at several locations over the circumference of the piston ring.

In order to obtain a stronger and accelerated distribution of the lubricating oil and thereby also reduce the required amount supplied, the invention proposes to configure the actual bearing surface to be variable in its width over the circumference of the piston ring. As shown in FIG. 1, the axial width (or height) of the bearing surface (or of the substantially flat region which forms this) has maxima at periodically distributed locations, for example, at the location of the cross-section A-A and on the left next to the location of the cross-section B-B. Located between the periodically distributed locations having maximum width are regions of the bearing surface 2 having minimal width, such as for example at the location of the cross-section C-C.

Due to the variable width of the bearing surface 2, hydrodynamic pressures and pressure gradients are produced in the oil film, which provide for an increased and accelerated transport of the oil in the circumferential direction of the piston ring 1. In the exemplary embodiment shown, the locations of maximum width have apexes 4 tapering approximately to a point in order to reinforce this effect particularly at the locations of the apexes 4. In the exemplary embodiment shown, it can also be identified that the central point in the axial direction of the bearing surface 2 also varies periodically with the width. This also ensures that the oil transport is excited in the circumferential direction. Alternatively however, it is also possible (not shown) that merely the width varies but the central point of the bearing surface is disposed at a constant (central or eccentric) position relative to the flanks over the circumference of the piston ring.

FIG. 2 shows cross-sectional views through the corresponding locations of the piston ring from FIG. 1. It can easily be seen here that on the one hand, the central point of the bearing surface is variable relative to the flanks, in section A-A further up, in section B-B further down and in section C-C centrally. Furthermore, the variable width can be seen where the width a of the bearing surface of section A-A is greatest, the width b of section B-B is slightly smaller and the width c of section C-C is the smallest.

FIG. 3 finally shows the embodiment from FIGS. 1 and 2 in an axial top view. The periodic distribution of the variation in the width of the bearing surface according to sections A and B can be seen, in addition the periodic variation is configured symmetrically to the joint 3 of the piston ring. Alternatively however it is also possible (not shown) that the periodic variation is configured asymmetrically to the joint 3 of the piston ring. The number of complete periods in this example is 5.

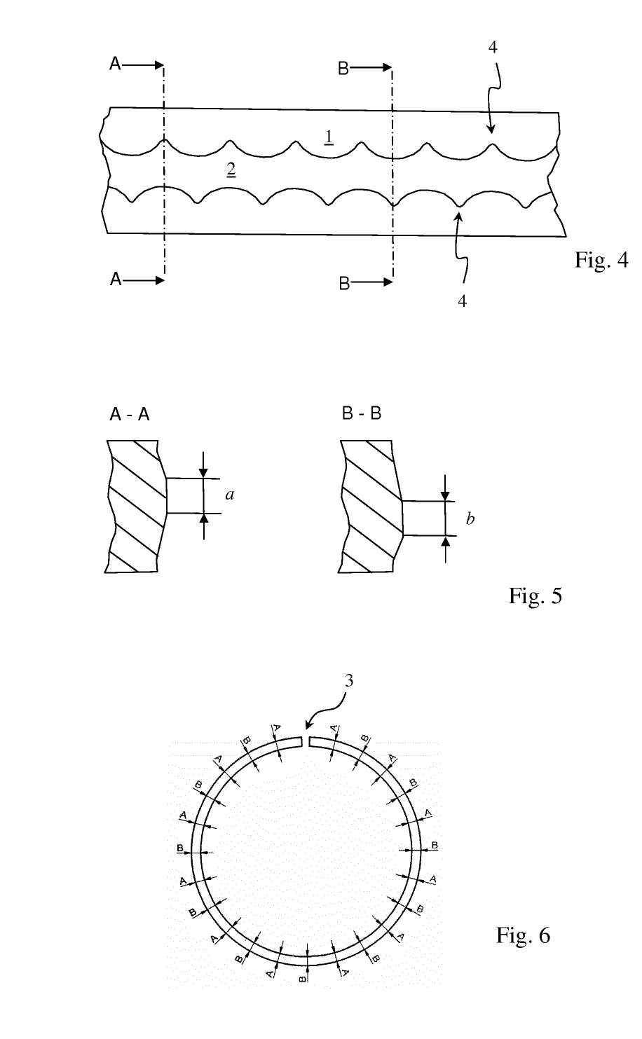

FIG. 4 shows a top view of the bearing surface side of a second embodiment of a piston ring 1 according to the invention. In this embodiment the bearing surface 2 of the piston ring 1 also has apexes 4 which taper approximately to a point. The relative variation of the width of the bearing surface 2 is smaller than in the embodiment from FIGS. 1-3 but here also the minima of the width are located between two adjacent apexes on different edges of the bearing surface 2. In this example, the apexes 4 of the upper or lower edge are offset with respect to one another by approximately a quarter period. Other phase shift values (not shown) are also possible. With a phase shift of 0 it can be achieved that the central point is fixed but the width is further variable over the circumference.

FIG. 5 shows cross-sections according to FIG. 4. The width a of section A-B in the example shown is the same as the width b of section B-B but can also be different. In the cross-section it can also be seen here that the position of the central point of the bearing surface 2 with respect to the flanks is variable over the circumference of the piston ring.

FIG. 6 finally shows the embodiment of FIGS. 4 and 5 in an axial top view. The periodic distribution of the variation in the width of the bearing surface according to sections A and B can be seen, in addition the periodic variation is configured symmetrically to the joint 3 of the piston ring. Alternatively however it is also possible (not shown) that the periodic variation is configured asymmetrically to the joint 3 of the piston ring, possibly with a corresponding offset, for example by a half period. The number of complete periods in this example is 33.

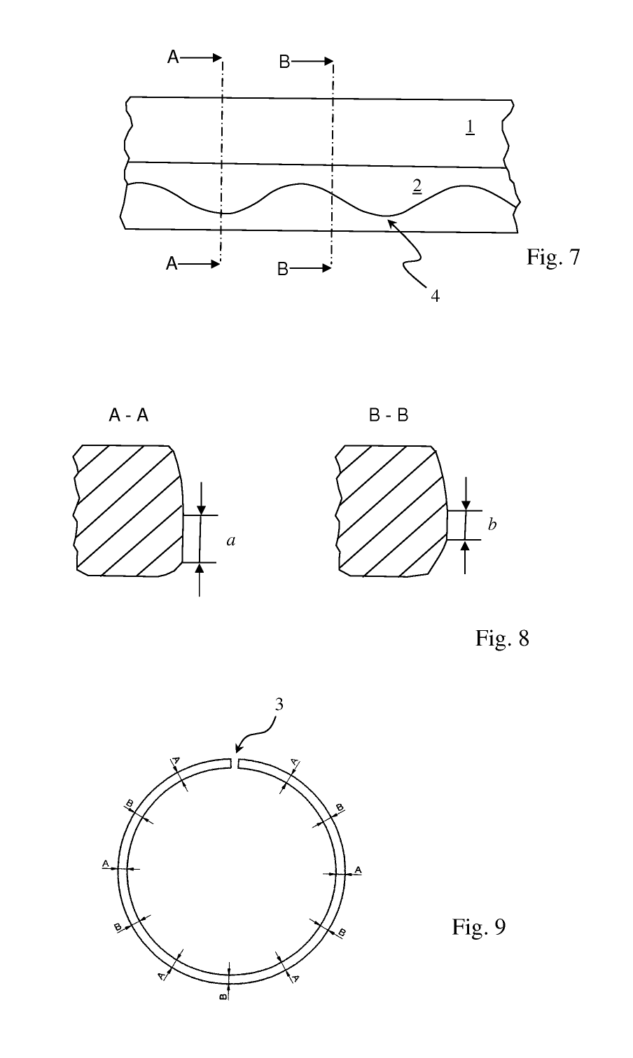

FIG. 7 shows a top view of the bearing surface side of a third embodiment of a piston ring 1 according to the invention. In this embodiment the bearing surface 2 of the piston ring 1 has rounded apexes 4 which follow a sinusoidal profile. The apexes 4 are only located on one—here the lower—edge of the bearing surface 2 whereas in this example, the other—here upper—edge runs parallel to the flank of the piston ring 1. As a result, the hydrodynamic pressures and pressure gradients can only be specifically produced on one side in order to thus selectively influence the oil transport in the circumferential direction only on this side. Preferably this is used on the side of the piston ring facing away from the combustion chamber, i.e. the parallel edge of the bearing surface is facing the combustion chamber. Alternatively however the converse case is also possible (not shown).

FIG. 8 shows cross-sections corresponding to FIG. 7. The width a of section A-A is greater than the width b of section B-B. In the cross-section it can also be seen here that the position of the central point of the bearing surface 2 with respect to the flanks is also variable over the circumference of the piston ring. Alternatively however it is also possible (not shown) that only the width is variable over the circumference but the central point is arranged fixedly with respect to the flanks.

FIG. 9 finally shows the embodiment of FIGS. 7 and 8 in an axial top view. The periodic distribution of the variation in the width of the bearing surface according to sections A and B can be seen, in addition the periodic variation is configured symmetrically to the joint 3 of the piston ring. Alternatively however it is also possible (not shown) that the periodic variation is configured asymmetrically to the joint 3 of the piston ring, possibly with a corresponding offset, for example by a half period. The number of complete periods in this example is 5. Different numbers of periods are also possible and the number of periods can be both even and odd.

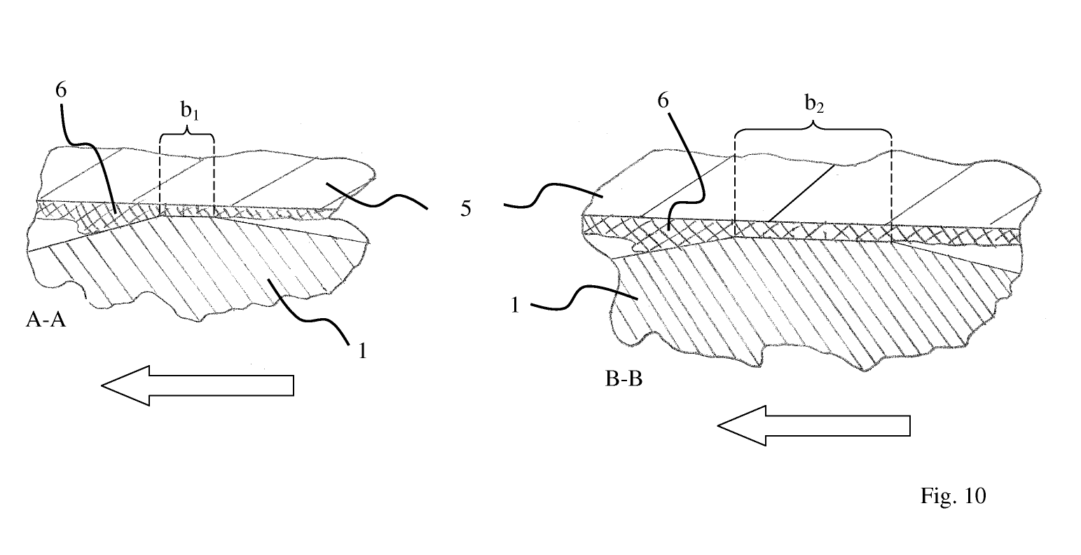

FIG. 10 shows two cross-sectional views through a piston ring according to an embodiment in which the bearing surface or the witness line varies in width. The cross-section A-A has a smaller width b₁ whereas the cross-section B-B has a greater width b₂. The running direction of the piston ring 1 is indicated by an arrow in each case (with fixed liner or cylinder wall 5). An oil film 6 having increased thickness is formed on the front sections of the bearing surface in the direction of movement.

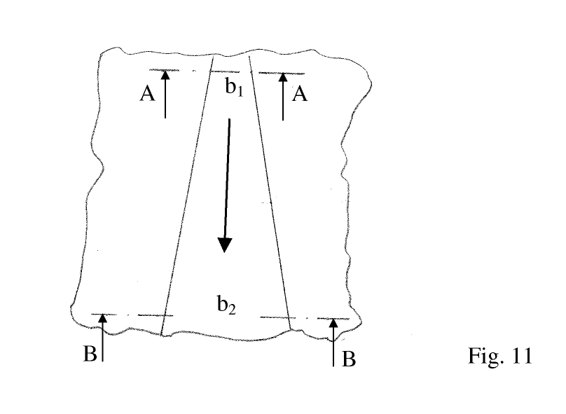

FIG. 11 shows a radial top view of the embodiment from FIG. 10. Here a substantially linear profile of the bearing surface or witness line width is shown as an example, where other nonlinear profiles are also possible, possibly as in the preceding embodiments. In this configuration oil transport (indicated by an arrow) is accomplished from the location of smaller width b₁ towards the location of greater width b₂. If this variation of the width in sawtooth manner is asymmetrical depending on circumferential direction around the piston ring, overall oil transport in the direction of greater width can thereby be achieved.

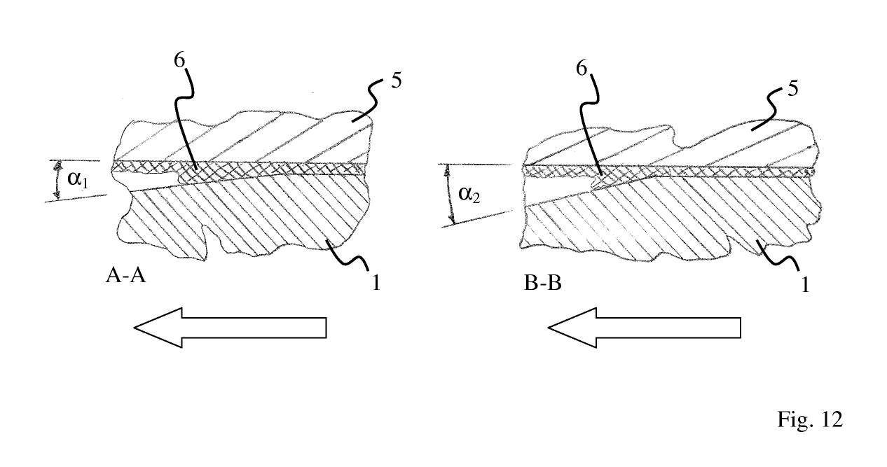

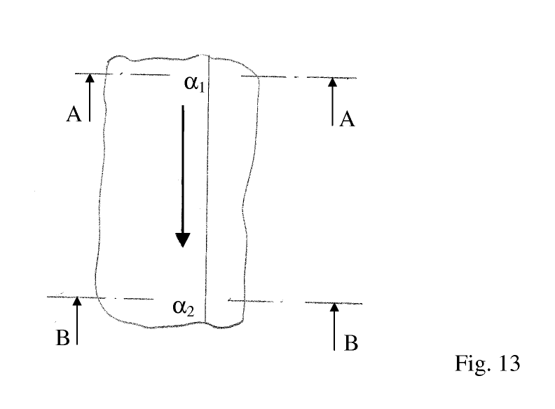

FIG. 12 shows two cross-sectional views through a piston ring according to an embodiment in which the angle between bearing surface or witness line and a (here the front flank in the direction of movement of the piston ring) varies. The cross-section A-A has a smaller angle α₁ whereas the cross-section B-B has a larger angle α₂. The running direction of the piston ring 1 is indicated by an arrow in each case (with fixed liner or cylinder wall 5). An oil film 6 having increased thickness is formed on the front sections of the bearing surface in the direction of movement.

FIG. 13 shows a radial top view of the embodiment from FIG. 12. Here a substantially linear profile of the angle between bearing surface or witness line is shown as an example, where other nonlinear profiles are also possible, possibly as in the preceding embodiments. In this configuration oil transport (indicated by an arrow) is accomplished from the location of the smaller angle α₁ towards the location of the larger angle α₂. If this variation of the width in sawtooth manner is asymmetrical depending on circumferential direction around the piston ring, overall oil transport in the direction of the larger angle can thereby be achieved. In each case, oil transport in the direction of the larger angle is excited merely due to the angular differences.

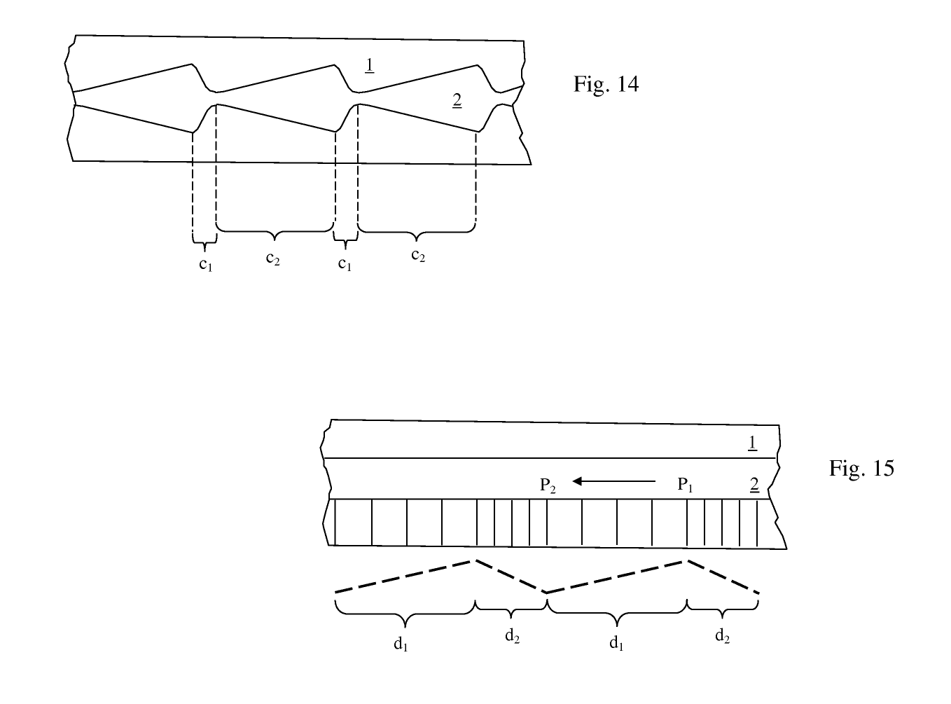

FIG. 14 shows in a radial top view, for example, corresponding to the embodiment of FIG. 10, how an asymmetrical profile of the variation of the width of the bearing surface or the witness line per circumferential direction around the piston ring according to one embodiment of the invention can look. The profile corresponds here for example to a sawtooth curve but other differently symmetrical profiles according to circumferential direction are also possible. The width of the bearing surface or the witness line decreases relatively strongly in the shorter regions c₁ from the maximum to the minimum width (when viewed from left to right). In the longer regions c₂ in comparison, the width increases again relatively weakly from the minimum to the maximum width (also when viewed from left to right). In the opposite viewing direction, i.e. from right to left, this profile is precisely reversed. Consequently, overall a variation is achieved which is inherently symmetrical per circumferential direction but asymmetrical between the circumferential directions which overall brings about oil transport in the circumferential direction (in the example shown here from left to right) when the piston ring moves.

FIG. 15 shows in a radial top view, for example, corresponding to the embodiment of FIG. 12, how an asymmetrical profile of the variation of the angle between the bearing surface or the witness line and the flank of the piston ring per circumferential direction around the piston ring according to one embodiment of the invention can look. The profile corresponds here for example to a sawtooth curve but other differently symmetrical profiles according to circumferential direction are also possible. The angle of the bearing surface or the witness line with respect to the flank decreases relatively weakly in the longer regions d₁ from the maximum to the minimum angle (when viewed from left to right). In the shorter regions d₂ in comparison, the angle increases again relatively strongly from the minimum to the maximum width (also when viewed from left to right). In the opposite viewing direction, i.e. from right to left, this profile is precisely reversed. Consequently, overall a variation is achieved which is inherently symmetrical per circumferential direction but asymmetrical between the circumferential directions which overall brings about oil transport in the circumferential direction (in the example shown here from left to right) when the piston ring moves.

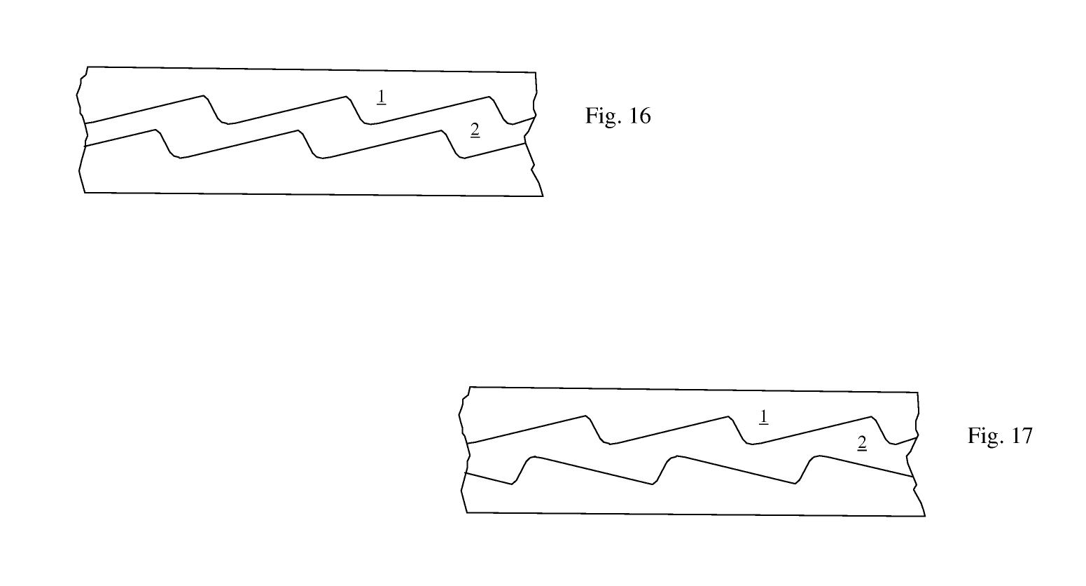

FIGS. 16 and 17 show further alternative embodiments of different profiles of the variation of the bearing surface according to circumferential direction.

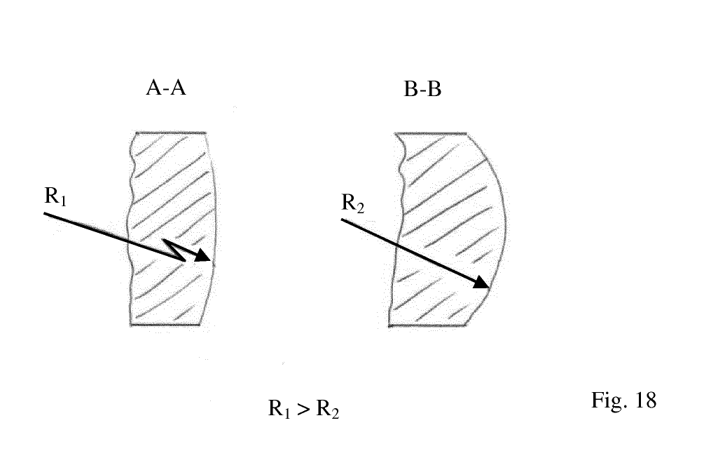

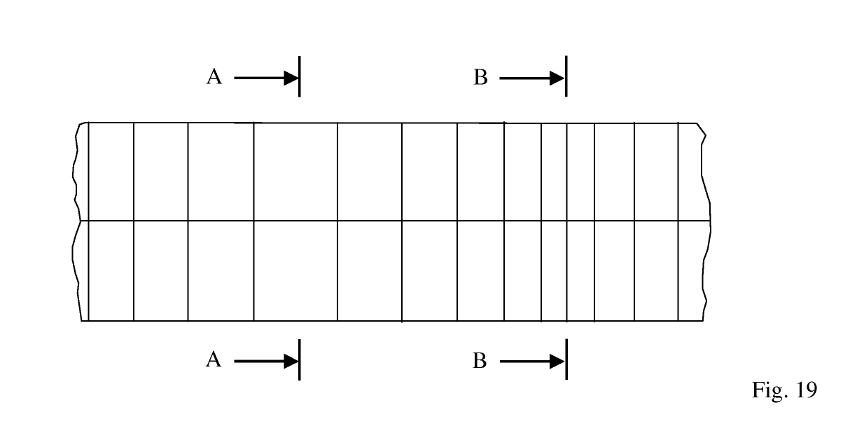

FIG. 18 shows two different cross-sections through a further embodiment of a piston ring according to the invention. Shown on the left side is a section A-A which has a spherical profiling with a relatively larger radius R₁. Shown on the right side is a section B-B which has a spherical profiling with a relatively small radius R₂. A small radius results in a relatively small contact surface on the cylinder liner or surface and therefore a relatively small witness line width whereas a large radius results in a relatively large witness line width.

FIG. 19 shows a top view showing a piston ring configured according to FIG. 18. In the region of the section A, the radius of the spherical profiling is larger, whilst it is smaller in the region of the section B. The apex line runs centrally here. The perpendicular dashes indicate the periodic variation of the radius of the bearing surface profiling where large distances between the dashes indicate relatively larger radii and small distance indicate relatively smaller radii. This variation has a minimum of the radius in the region of the section B and a maximum of the radius in the region A.

A piston ring configured according to the present invention can preferably be inserted in a piston ring groove in pistons for internal combustion engines such as, for example, large-volume two-stroke internal combustion engines or compressors. Here it has been shown that on the one hand the oil consumption and on the other hand the blow-by could be reduced considerably compared with known designs. It should therefore be noted that an improved piston ring for pistons of an internal combustion engine or compressor is provided with the piston ring according to the invention which achieves exceptionally good results with regard to blow-by and oil consumption with ensured lubricating conditions.

1. Piston ring (1) having an outside circumferential surface, an inside circumferential surface and two flanks, wherein the circumferential surface has a spherical profiling, and wherein
the spherical profiling has a substantially flat apex region which defines the bearing surface (2) of the piston ring (1), and wherein the axial width (b₁, b₂) of the bearing surface (2) varies periodically over the circumference of the piston ring (1); and/or
the spherical profiling has a substantially flat apex region which defines the bearing surface (2) of the piston ring (1), and wherein the angle (α₁, α₂) between the bearing surface (2) and at least one flank varies periodically over the circumference of the piston ring (1); and/or
wherein the radius (r₁, r₂) of the spherical profiling varies periodically over the circumference of the piston ring (1).

2. The piston ring (1) according to claim 1, wherein the axial position of the centre of the bearing surface or the spherical profiling (2) varies periodically.

3. The piston ring (1) according to claim 1 or 2, wherein the variation of the width (b₁, b₂) and/or the position of the centre of the bearing surface (2) and/or the angle (α₁, α₂) and/or the radius (r₁, r₂) comprises at least one complete period.

4. The piston ring (1) according to any one of the preceding claims, wherein
the variation of the width (b₁, b₂) and/or the position of the centre of the bearing surface (2) is symmetrical in relation to the ring joint (3) of the piston ring (1); and/or
the variation of the angle (α₁, α₂) between the bearing surface (2) and the at least one flank is symmetrical in relation to the ring joint (3) of the piston ring (1);
and/or
the variation of the radius (r₁, r₂) of the spherical profiling is symmetrical in relation to the ring joint (3) of the piston ring (1).

5. The piston ring (1) according to any one of claims 1 to 3, wherein
the variation of the width (b₁, b₂) and/or the position of the centre of the bearing surface (2) is asymmetrical in relation to the ring joint (3) of the piston ring (1); and/or
the variation of the angle (α₁, α₂) between the bearing surface (2) and the at least one flank is asymmetrical in relation to the ring joint (3) of the piston ring (1);
and/or
the variation of the radius (r₁, r₂) of the spherical profiling is asymmetrical in relation to the ring joint (3) of the piston ring (1); and/or
the behaviour of the variation of the width (b₁, b₂) and/or the position of the centre of the bearing surface (2) when viewed in the circumferential direction of the piston ring (1), is different per circumferential direction; and/or
the behaviour of the variation of the angle (α₁, α₂) between the bearing surface (2) and the at least one flank when viewed in the circumferential direction of the piston ring (1), is different per circumferential direction;
and/or
the behaviour of the variation of the radius (r₁, r₂) of the spherical profiling when viewed in the circumferential direction of the piston ring (1), is different per circumferential direction.

6. The piston ring (1) according to any one of the preceding claims, wherein an edge of the bearing surface (2) runs parallel to the neighbouring flank.

7. The piston ring (1) according to any one of claims 1 to 5, wherein both edges of the bearing surface (2) each have apexes (4) at which the axial distance from the neighbouring flank has a minimum and wherein the apexes (4) are disposed in the circumferential direction alternately on respectively one of the opposite edges of the bearing surface (2).

8. The piston ring (1) according to claim 7, wherein the axial width (b₁, b₂) has a maximum at the apexes (4).

9. The piston ring (1) according to any one of the preceding claims, wherein the minimum axial width of the bearing surface (2) is 20% of the maximum width.

10. The piston ring (1) according to any one of the preceding claims, wherein the axial width (b₁, b₂) of the bearing surface (2) is between 0.1 and 3 cm, preferably between 0.2 and 1.5 cm.

11. The piston ring (1) according to any one of the preceding claims, wherein the axial width (b₁, b₂) of the bearing surface (2) is 5% to 50% of the axial width of the piston ring (1).

12. The piston ring (1) according to claim 5 or one of claims 6 to 11 if dependent on claim 5, wherein the variation of the width (b₁, b₂) or the variation of the angle (α₁, α₂) or the variation of the radius (r₁, r₂) is a variation whose ascending or descending flanks ascend/descend more strongly in one direction of revolution than in the opposite direction of revolution.
